(19) United States
(12) Patent Application Publication
(10) Pub. No.: US 2007/0282502 A1
(43) Pub. Date: Dec. 6, 2007

(54) Parking Aid

(75) Inventors: Ronald Bayer, Muhlmeim/Main (DE); Ralf Schwarz, Igolstadt (DE); Stefan Luke, Olpe (DE); Dirk Frohlich, Burstadt (DE)

Correspondence Address: CONTINENTAL TEVES, INC., ONE CONTINENTAL DRIVE, AUBURN HILLLS, MI, 48326-1581, US

(73) Assignee: Continental Teves AG & Co. oHG

(21) Appl. No.: 10/582,260

(22) PCT Filed: Nov. 30, 2004
(86) PCT No.: PCT/EP04/53174

§ 371 Date: Apr. 17, 2007

(30) Foreign Application Priority Data
Dec. 9, 2003 (DE) 10357708.4
Mar. 5, 2004 (DE) 10200401409.9
Nov. 18, 2004 (DE) 102004055584.2

(51) Int. Cl. B62D 6/00

(52) U.S. Cl. 701/42

(57) ABSTRACT

In the case of a parking aid for a motor vehicle having a vehicle steering system with a manual steering wheel and a steering torque regulating module by means of which a steering torque can be applied to the steering wheel, the parking aid cooperates with the torque regulating module according to this invention and an additional steering torque is applied via the steering wheel by means of which the driver of the vehicle is assisted in a parking maneuver.

The invention relates to a parking aid for a motor vehicle, consisting a vehicle steering with a manual steering wheel and a steering torque regulating module by which a steering torque can be impressed upon the steering wheel.

The present invention likewise relates to a steering torque regulating module for a motor vehicle having a steering.

The present invention also relates to a method for driver steering assistance.

The present invention also relates to a driver recognition module for a motor vehicle.

Furthermore, the present invention also relates to a longitudinal dynamic control module for a motor vehicle.

The present invention likewise relates to a motor vehicle having motor vehicle steering comprised of a manual steering wheel and a steering torque regulating module and having a parking aid.

Today's parking aids instruct the driver with visual or acoustic means regarding the size of the remaining parking space they give visual and/or audio handling instructions for parking in the parking space. The display means required for this purpose must often be installed extra and offer only a limited gain in terms of convenience.

Fully automatic methods entail the risk that the driver feels relieved of responsibility. This could lead to an accident in the event of a system failure.

The object of the present invention is to create a parking aid which supports the driver and at the same time ensures that the driver can control the vehicle and thus retains responsibility for the parking procedure.

This object is achieved by the features of the independent patent claims.

Preferred embodiments are characterized in the subclaims.

This object is achieved by a parking aid for a motor vehicle having a vehicle steering system comprised of a manual steering wheel and a steering torque regulating module by which a steering torque can be applied to the steering wheel; it is characterized in that the parking aid cooperates with the steering torque regulating module and an additional steering torque is applied to the steering wheel by means of which the driver of the vehicle is supported in a parking procedure.

The parking aid gives the driver in the sense of the present invention handling instructions for steering through an additional steering torque. This haptic feedback supports the driver in parking in a manner that is convenient for him.

If the driver follows the handling instructions for steering, i.e., correctly implements the corresponding steering instructions applied through the additional steering torque, the driver will certainly be in agreement with the steering operation.

This yields as an advantage of the present invention the fact that the vehicle essentially cannot be steered contrary to the intent of the driver. The driver thus also continues to feel responsible and therefore will guide the vehicle according to his intent.

According to this invention, the additional steering torque applied to the steering wheel generates at least an artificial steering stop, preferably one or two steering stops.

The “artificial steering stop” here means that beyond a certain position of the steering wheel, a sharply increasing steering torque is applied, so the driver senses a relatively great resistance, a “counter torque,” when he turns the steering wheel further in this direction.

This indicates to the driver that he should not turn the steering wheel further in this direction.

According to this invention, it is provided that the driver is guided by the extra steering torque applied to the steering wheel in his driving activities in the parking procedure.

This means that through a continuous change in the additional steering torque applied, during the parking procedure the driver is constantly being given an indication of the point, i.e., the steering wheel position, beyond which he should not attempt to steer the steering wheel further in a certain direction if the driver is steering “correctly” if the driver then follows the handling instructions for steering, he will not sense any increased resistance in his steering maneuvers. In this way the driver can park the vehicle himself safely and deliberately.

If the driver operates the steering wheel automatically in such a manner that the parking procedure takes place automatically, i.e., if the driver steers the vehicle “correctly” on his own, there will be no change in the applied torque.

In one embodiment, it is provided that the steering torque applied to the steering wheel (steering assist torque) is limited as a function of a steering work applied by the driver or a quantity dependent thereon.

This object is also achieved by a parking aid for a vehicle comprising a vehicle steering having a manual steering wheel and is characterized in that the parking aid has means for applying at least one steering stop, preferably one or two steering stops by means of which the driver is guided in his steering maneuvers in the parking procedure.

This object is also achieved by a steering torque regulating module for a motor vehicle having a steering system, in particular for a parking aid according to this invention, whereby changes in the restoring torques of the steering system are determined; these changes are applied as a function of the steering angle. Taking into account the changes in the restoring torques, an additional steering torque is applied to the steering wheel to assist the driver of the vehicle in the parking procedure.

According to this invention, it is provided that in the steering torque regulating module, the steering torque applied additionally to the steering wheel generates at least one artificial steering stop, preferably one or two steering stops. By means of the additional steering torque applied to the steering wheel and the artificial steering stop, the driver is guided in his steering maneuvers in the parking procedure.

In one embodiment, it is provided that in the steering torque regulating module, the steering torque applied to the steering wheel (steering assist torque) is adjustable variably as a function of a steering work applied by the driver or a quantity that depends thereon.

According to this invention, in the steering torque regulating module, the steering assist torque is reduced in a case of a more rapid operation of the steering wheel or a quantity depending thereon, i.e., a greater steering wheel speed.

This object is also achieved by a method for driver steering assistance, in particular for a parking aid or a steering torque regulating module for a motor vehicle according to this invention which is characterized in that the method supports the driver of a vehicle in a parking procedure by means of a steering torque applied to the steering wheel, in which case the driver is guided by an artificial steering stop and the steering torque applied to the steering wheel (steering assist torque) is limited as a function of the steering work applied by the driver or a quantity depending thereon.

This object is achieved by the driver recognition module for a vehicle, in particular for a parking aid or a steering torque regulating module or a method for driver steering support according to this invention in which the driver of a vehicle is identified by means of a measured steering torque against at least one artificial steering stop, preferably one or two steering stops, this steering stop being generated via an additional steering torque applied to the steering wheel.

According to this invention, it is provided that with the driver recognition module, the driver is identified by a measured steering angle within a rising steering torque of the artificial steering stop.

With the driver recognition module according to this invention, a power needed for a steering torque actuator, in particular an electric motor, is determined and a driver steering torque is determined on the basis of the power needed for the steering torque actuator.

This object is also achieved by a longitudinal dynamics control module for a vehicle, in particular for a parking aid or a steering torque regulating module according to the present invention in which the speed of the vehicle is controlled as a function of the position of the accelerator pedal through automatic braking intervention when maneuvering into a parking space.

According to this invention, when maneuvering into a parking space, the speed of the vehicle equipped with the longitudinal dynamics control module is controlled by additional intervention into the engine torque of the driving engine of the vehicle as a function of the position of the brake pedal.

With the longitudinal dynamics control module according to this invention, when maneuvering into a parking space, the speed of the vehicle is controlled by additional intervention into an engine torque of a driving engine of the vehicle and intervention by automatic gear-shifting of the vehicle transmission as a function of the position of the brake pedal.

According to this invention, with the longitudinal dynamics control module, the end of a parking space is determined and on reaching or just before reaching the end of the parking space, the vehicle is automatically braked.

This object is also achieved by a vehicle having an automotive steering system using a manual steering wheel and a steering torque regulating module and having a parking aid comprised of a steering torque regulating module, a driver recognition module and a longitudinal dynamics control module according to this invention.

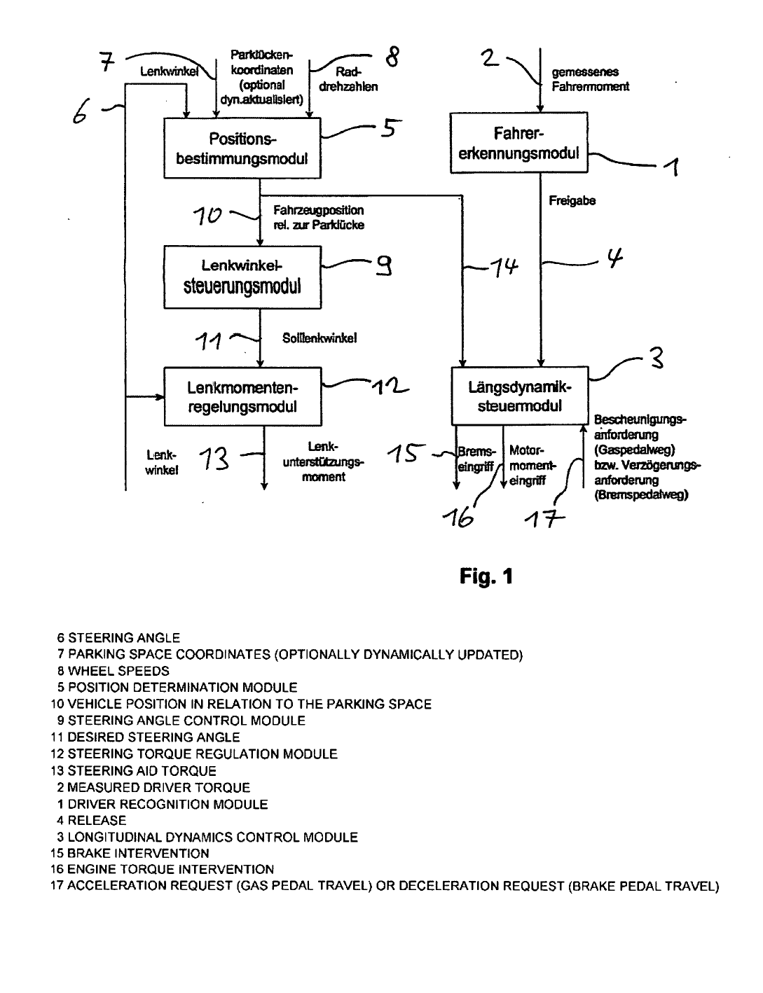

This invention is explained in greater detail below as an example on the basis of three illustrations (FIGS. 1 through 3).

FIG. 1 shows a flow chart of the individual modules for the parking aid and how they cooperate.

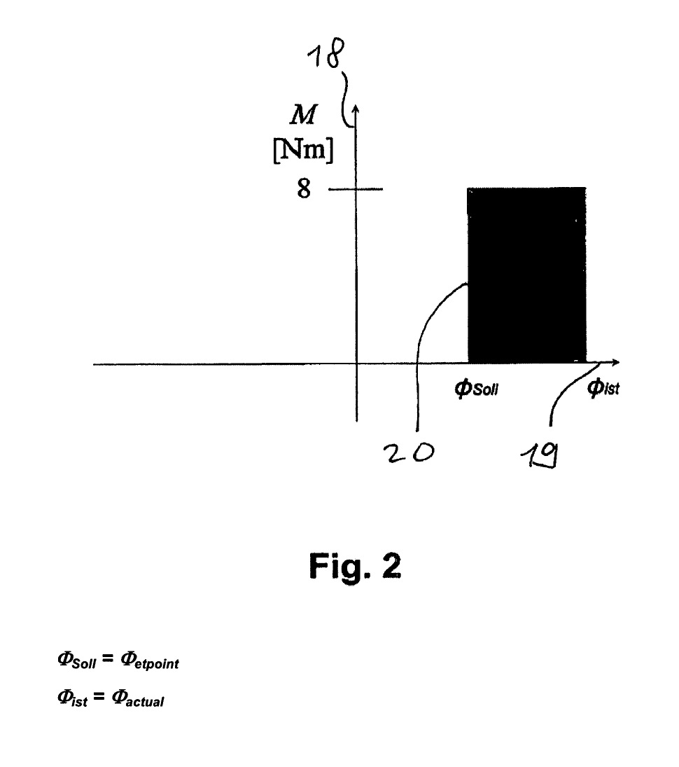

FIG. 2 shows schematically how the additional steering torque is applied.

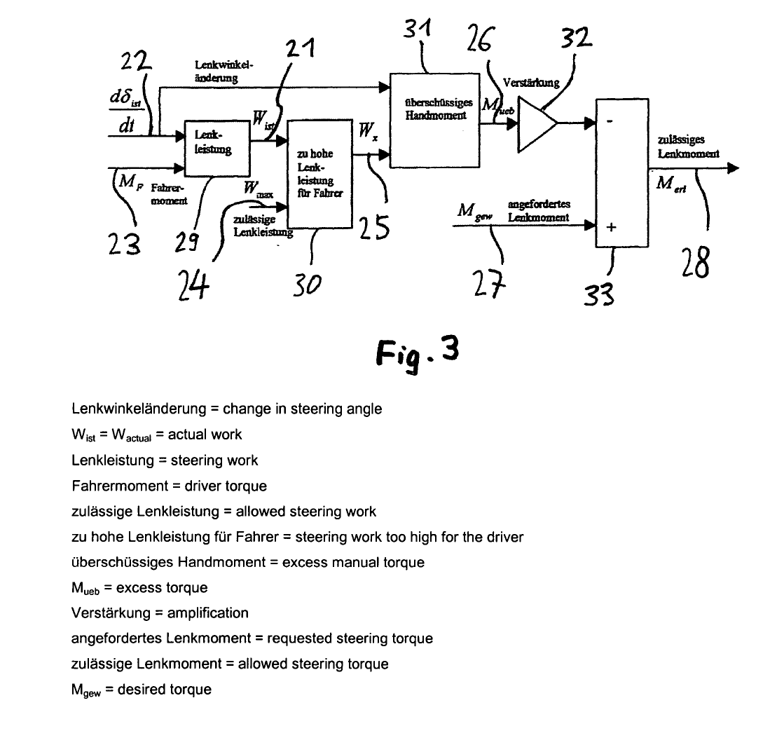

FIG. 3 shows how the steering torque (steering assist torque) applied to the steering wheel is limited.

The parking aid illustrated in FIG. 1 has a driver recognition module (1) which triggers (4) a longitudinal dynamics control module (3) as a function of a measured steering torque (2) applied by the driver.

The parking aid also has a module (5) for determining the position of the vehicle. The position of the vehicle is determined according to a measured steering angle (6), parking space coordinates (7) and measured wheel rotational speeds (8). The position of the vehicle in relation to the parking space (10) is supplied to a steering angle control module (9).

The steering angle control module (9) generates a setpoint steering angle as an output signal (11) and transfers this desired steering angle to a steering torque regulating module (12), which regulates the additional steering torque, the steering assist torque (13), as a function of this desired steering angle (11) and the measured steering angle (6).

The position of the vehicle in relation to the parking space (10) is also sent to the longitudinal dynamics control module (3) as parking space coordinates (14). The longitudinal dynamics control module (3) controls the longitudinal dynamics by means of a braking intervention (15) and/or an engine torque intervention (16). As additional input quantities, an acceleration request or a deceleration request is sent (17) to the longitudinal dynamics control module (3), these requests being determined, for example, on the basis of the distance of travel of the accelerator pedal and the brake pedal.

It is essential for the present invention that an artificial steering stop is generated for the driver during the parking procedure by means of a suitable torque application in the steering torque regulating module (12). This helps the driver to select the correct steering angle as calculated in the steering angle control module (9). Depending on the torque applied by the driver, a check is performed in the driver recognition module (1) to determine whether the driver is properly monitoring the parking procedure.

In parallel with that, the driver is assisted by the longitudinal dynamics control module (3) in controlling the vehicle speed. Collisions with vehicles adjacent to the parking space are prevented here by automatic braking intervention measures (15) as a function of the driver recognition (4) and the position of the vehicle in relation to the parking space coordinates (14) calculated in the position-determining module (5).

To do so, according to this invention, a steering system is provided so that an additional steering torque can be superimposed on the steering system externally, i.e., added or subtracted. The vehicle advantageously has an electronic brake system which is capable of setting external brake pressure settings and an engine management that allows external intervention into the engine torque.

FIG. 2 shows the additional steering torque applied in steering torque regulation by the steering torque regulating module (12) where the steering torque (M) is plotted as a function of the steering angle Φ (19).

In regulating the steering torque, a virtual steering stop (20) is generated as a function of the measured steering angle (6) Φ_{actual}; this steering stop is shifted during the parking procedure as a function of the setpoint steering angle Φₛₑₜₚₒᵢₙₜ so that the vehicle moves on a trajectory (path of vehicle movement) into a parking space if the driver keeps the steering constantly directly at the steering stop and follows it.

According to this invention the driver is supported by various alternative strategies during parking.

In one embodiment, the driver is “captured” by the steering torque in a first strategy and automatically guided into the parking space. To do so the artificial steering stop is placed on the left when parking on the right and is placed on the right when parking on the left.

In a second alternative strategy, the driver is instructed to park the vehicle in the parking space against the steering resistance. Then the artificial steering stop is placed on the right when parking on the right and on the left when parking on the left.

Another strategy is also provided whereby there is a steering stop on both sides. This combination facilitates countersteering for the driver during the parking procedure.

The steering stop is controlled by the steering angle control module (9). It calculates a trajectory for maneuvering into the parking space as a function of the parking space information and the vehicle position (10). It also calculates a steering angle (11) as a function of this calculated trajectory and the changing vehicle position (10).

The vehicle position is calculated in the position-determining module (5) continuously during the parking procedure in relation to the measured parking space coordinates (7). Input quantities here include the steering angle (6), the wheel speeds (8) and optional information from the distance sensors (7).

To check on whether the driver is keeping the steering wheel at the artificial steering stop, the steering torque (2) applied by the driver is determined. The steering torque may be either measured or calculated.

A driver recognition module (1) checks on whether the steering torque applied by the driver against the artificial steering stop has a defined threshold value, preferably approximately 0.5 to 3 Nm, especially approx. 1 Nm. As long as the steering torque applied by the driver exceeds this threshold value, the parking procedure may be continued. As soon as the driver's steering torque is too weak, the parking procedure is stopped or terminated by a braking intervention measure (15). Furthermore, the driver's attention may be drawn to the fact that he needs to continue steering against the steering stop and this may be accomplished by another steering signal such as an increasing torque in the opposite direction or a vibration of the steering wheel.

According to another embodiment of the present invention, the method described here may also fundamentally be used with a suitable driver manual torque recognition because the application of a torque as described above against one of the two steering stops represents only a (simple) variant. According to this invention, that the difference between a model which calculates the torque of a manual torque sensor and a manual torque that is actually measured is determined by subtraction. As a result, a manual driver torque which permits driver recognition is determined.

The speed of the vehicle is influenced by the longitudinal dynamics control module (3). The driver also determines the maximum speed via a pedal (accelerator pedal or brake pedal). The brake and engine torque are coordinated so that the speed specified by the pedal is established.

According to this invention the driver controls the vehicle speed through the position of the accelerator pedal. Regulation of control by the accelerator pedal position, referred to as “accelerator pedal control,” is described below.

Without touching the accelerator pedal, the desired vehicle speed is 0 Km/h and when the accelerator pedal is fully depressed, the desired vehicle speed corresponds to the maximum parking speed. The engine torque becomes greater when the desired speed corresponding to the accelerator pedal position is greater than the measured speed. The engine torque becomes weaker when the desired speed is below the measured speed. If this difference increases or if the desired speed is or is close to 0 Km/h, then the brake is additionally activated by an intervention measure (15).

According to this invention, the driver can also use the setting of the brake pedal to control the vehicle speed. In regulation through brake pedal position, the strategy known as “brake pedal control,” the desired vehicle speed without actuation of the brake pedal corresponds to the speed resulting from the given gear setting and the idling engine speed. When the brake pedal is fully depressed, the desired vehicle speed is 0 Km/h.

The brake force is higher when the brake pedal is depressed more and the engine torque is reduced according to the difference between the measured speed and the target speed. To have enough play in the brake pedal to control the speed with little or no brake force, it is necessary for certain applications to redetermine the brake pedal travel for the specific brake force.

According to this invention, the vehicle is also braked as a function of the position of the vehicle in relation to the obstacles detected. This includes stopping at the end of the parking space and braking on departing from the planned trajectory (path of travel).

The vehicle may optionally be braked as a function of the driver recognition. The vehicle may also be braked as soon as the driver's torque has exceeded a threshold value, preferably 3 Nm to 10 Nm, especially approx. 6 Nm. In this case the vehicle is stopped until the correct steering torque prevails again. This makes it difficult to or even prevents the driver from unintentionally departing from the preselected trajectory.

The function of the parking aid is terminated on reaching the correct parking position. In addition there are other termination criteria.

If the driver has been braked automatically because of inadequate pressure against the artificial steering stop, and if the driver has nevertheless been requesting acceleration by depressing the accelerator pedal over a defined period of time without making any change in steering angle, then the function of the parking assist is terminated.

The parking procedure is also terminated if the maximum torque of the artificial steering stop has been exceeded and the vehicle has come to a stop.

In parallel with the haptic feedback to the steering wheel and the automatic braking intervention measures, the driver may also be notified of handling instructions by way of existing or additional message devices.

These measures assist the driver in parking the vehicle. At the same time, he retains the responsibility for monitoring the parking procedure and terminating it if necessary.

It is a special advantage of this parking aid that it is operable in compact vehicles having electric servo steering and preferably with an electronic brake system with autonomous brake intervention options such as the electronic stability program (ESP) or traction control systems (TCS) that have already been installed in the vehicle to fulfill other functions.

In vehicles having hydraulic servo steering, this method can also be used when the servo steering is expanded by additional equipment such as an electric motor in the steering column for external steering torque demands. This method can be implemented in parts or combined with known methods. These include in particular the optic or acoustic instructions used today.

Limiting the torque applied to the steering wheel (steering assist torque) according to the other embodiment of the present invention is depicted in greater detail in a flow chart in FIG. 3.

In this special embodiment, the steering torque applied to the steering wheel (steering assist torque) is limited as a function of the steering work applied by the driver.

Essentially, limitation of the steering assist torque to regulating the steering angle for guided driving and/or following (driver assistance in which the driver steers automatically and is preferably being guided by a steering stop) or automatic following of a parking trajectory (parking path based on determination, monitoring and regulation of a target position of a target yaw angle) may be used.

According to the present invention, a steering angle regulator calculates a desired steering angle as a function of the regulating difference between the target position and the actual position of the midpoint of the rear axle and the regulating difference between the target yaw angle and the actual yaw angle of the vehicle for a parking procedure here.

To regulate the desired steering angle, it is then compared with the actual steering angle δ_{actual} to request a desired steering assist torque from the steering system as a function of the resulting regulating difference Δδ.

The driver should definitely sense the artificial steering stops that are set but the imposed torque must not become unpleasant. When the steering wheel is stationary or turning slowly a comfortable steering stop for a driver would be 8 Nm but at a higher speed of the steering wheel, this torque is unpleasant because of the greater change in steering angle. At higher speeds a lower torque is also easy to sense.

For this reason, the regulator limits the requested torque as a function of the steering work W_{actual} 21 applied by the driver.

To determine the steering work W_{actual} 21 the absolute value of the change in the steering angle dδ_{actual}÷dt 22 measured in the last time increment is multiplied times a driver torque M_{F} 23 measured in the same time increment by a manual torque sensor in the power-determining unit 29.

The work W_{actual} 21 thus calculated is subtracted from a defined maximum steering work Wₘₐₓ 24 in a limiting unit 30.

If the result is positive, this excessive work Wₓ 25 can be divided by the change in steering angle in an excess torque determining unit 31.

The excess torque M_{ueb} 26 calculated in this way may be provided with a factor in an amplification unit 32. Then in a subtraction unit 33 it is subtracted from a desired steering torque M_{gew} 27.

This yields the resulting limited steering assist torque Mₑᵣₗ 28 which is requested by the steering system.

Thus the method for limiting the assist torque has the following important steps:
determination of the manual torque by the driver
determination of the steering wheel rotational speed
reducing the assist torque even more the greater the steering wheel rotational speed

This method may be implemented in parts or combined with known methods. These include in particular the visual or acoustic messages used today in particular in addition to the methods described here.

1-18. (canceled)

19. A parking aid for a motor vehicle having a vehicle steering with a manual steering wheel; the parking aid comprising:
a steering torque control module for applying a steering torque to the steering wheel, wherein that the parking aid cooperates with the steering torque regulating module and an additional steering torque is applied to the steering wheel, supporting a driver of the vehicle in a parking procedure.

20. A parking aid according to claim 19, wherein the additional steering torque applied to the steering wheel generates one or more artificial steering stops.

21. A parking aid according to claim 19, wherein the driver is guided by the additional steering torque applied to the steering wheel during steering maneuvers in a parking procedure in a parking maneuver.

22. A parking aid according to claim 21, wherein the steering torque applied to the steering wheel is limited as a function of a steering work applied by the driver or a quantity depending thereon.

24. A parking aid according to claim 19, wherein changes in restore torques of the steering applied as a function of the steering angle are determined and the additional steering torque is applied to the steering wheel, taking into account the changes in the restore torques by which a driver of the vehicle is supported during a parking maneuver.

25. A parking aid according to claim 24, wherein the additional steering torque applied to the steering wheel generates two or more additional steering stops, and the driver is guided by the additional steering torque applied to the steering wheel during a steering maneuver in the parking procedure.

26. A parking aid according to claim 24, wherein the steering torque applied to the steering wheel is variably adjustable as a function of a steering work applied by the driver or a quantity dependent thereon.

27. A parking aid according to claim 24, wherein the steering assist torque is reduced in the event of a faster operation of the steering wheel or a quantity depending thereon such as greater rate of rotation of the steering wheel.

28. A parking aid according to claim 19, further comprising a longitudinal dynamics control module for controlling a speed of the vehicle in maneuvering into a parking space by automatic braking intervention measures as a function of a position of an accelerator pedal of the motor vehicle.

29. A parking aid according to claim 28, wherein when parking in a parking space, the speed of the vehicle is controlled by additional intervention into an engine torque of a drive engine of the vehicle as a function of the position of the brake pedal.

30. A parking aid according to claim 28, wherein when maneuvering into a parking space, the speed of the vehicle is controlled by additional intervention into the engine torque of the drive engine of the vehicle and by automatic gear-shifting of the vehicle transmission as a function of the position of the brake pedal.

31. A parking aid according to claim 28, wherein when an end of the parking space is detected, the vehicle is automatically braked on reaching the end or shortly before reaching the end of the parking space.

32. A parking aid for a motor vehicle having a vehicle steering with a manual steering wheel, the parking aid comprising:
a device for applying one or more steering stops to the manual steering wheel, wherein a driver is guided during steering maneuvers of a parking maneuver.

33. A driver recognition system for a motor vehicle, the system comprising:
a device for applying an additional torque to a steering wheel;
a device for applying one or more steering stops to the steering wheel using the additional torque applied to the steering wheel; and
a device for identifying a driver using a measured steering torque against the at least one or more artificial steering stops.

34. A driver recognition system according to claim 33, wherein the driver is identified by a measured steering angle within a rising steering torque of the one or more steering stops.

35. A driver recognition system according to claim 33, wherein work required for a steering torque actuator is determined and a driver steering torque is determined on the basis of the work required by the steering torque actuator.
